(19) United States
(12) Patent Application Publication
(10) Pub. No.: US 2002/0065900 A1
(43) Pub. Date: May 30, 2002

(54) Method and apparatus for communicating images, data, or other information in a defect source identifier

(75) Inventors: Amos Dor, Sunnyvale, CA (US); Maya Radzinski, Palo Alto, CA (US)

Correspondence Address: Patent Counsel, Applied Materials, Inc., 3050 Bowers Avenue, P.O. Box 450A, Santa Clara, CA, 95052, US

(73) Assignee: Applied Materials, Inc.

(21) Appl. No.: 09/905,313

(22) Filed: Jul. 13, 2001

Related U.S. Application Data
(60) Provisional application No. 60/240,631, filed on Oct. 16, 2000.
(60) Provisional application No. 60/237,297, filed on Oct. 2, 2000.

(51) Int. Cl. G06F 15/16

(52) U.S. Cl. 709/217; 709/203

(57) ABSTRACT

A method and associated apparatus for communicating defect information between a defect source identifier server and client. The method comprises creating defect inspection information within a defect source identifier client, the defect inspection information containing information regarding identified defects on semiconductor wafers. In one aspect, an XML converter converts the defect inspection information into converted defect inspection information that is in a form defined by user defined tags. The converted defect inspection information is transmitted through a network to a defect source identifier server. Defect source information is derived at the defect source identifier server in response to the converted defect inspection information.

### CROSS REFERENCE TO RELATED APPLICATIONS

This application claims benefit of U.S. provisional patent applications Ser. No. 60/240,631, filed Oct. 16, 2000, and Ser. No. 60/237,297, filed Oct. 2, 2000 which are herein incorporated by reference. This application contains subject matter that is related to the subject matter described in U.S. patent application Ser. No. ______ , ______, and ______, (Attorney dockets 4745FET/MDR, 4747FET/MDR, and 4748FET/MDR), filed simultaneously herewith, which are each incorporated herein by reference in their entireties.

### BACKGROUND OF THE DISCLOSURE

1. Field of the Invention

The invention relates to systems for analyzing wafer defects. More particularly, the invention relates to a method and apparatus for communicating wafer defect images or other information in a defect source identifier.

2. Description of the Background Art

Many techniques, e.g., optical systems, electron microscopes, spatial signature analysis, and energy dispersive x-ray microanalysis, are used to identify defects on a semiconductor wafer. To identify defects using these defect analysis techniques, wafers are intermittently selected from a lot of wafers that is being processed, i.e., one in every N wafers is selected. The selected wafers are analyzed using one or more of the above-identified analysis techniques using tools that are commonly referred to as metrology tools. The metrology tools produce images, data, and other information relating to the selected wafers. A skilled operator reviews the images and data recorded by the metrology tools to identify defects on the selected wafers.

The source of the defect is generally identified through trial and error, i.e., changes are made in the process parameters in an attempt to eliminate the defect in a wafer selected from another, subsequently processed lot. Some types of defects occur for well-known reasons. These defects are cataloged in a searchable database of defect data and images. An operator can compare the test results to the defect database in an attempt to match the test results to defects contained in the defect database. In instances where a match is found, the database provides a solution to the source of the wafer defect. The user, or the computer, can then take corrective action as provided by the solution to limit further occurrences of the defect.

The defect data and defect solutions are generally stored in a computer connected to the metrology tools. As such, in an integrated circuit factory having many sets of metrology tools, the defect data is dispersed amongst the tools and their computer systems.

Therefore, there is a need for a method and apparatus for communicating defect, defect source and defect solution information amongst tools within a factory or even between factories using a common communication protocol.

### SUMMARY OF THE INVENTION

The present invention generally provides a method and apparatus for communicating defect, defect source and defect solution information to various locations within an integrated circuit factory between factories, or to and from a centralized defect knowledge library. The method comprises creating defect inspection information within a defect source identifier client, the defect inspection information containing information regarding identified defects on semiconductor wafers. In one aspect, an extensible mark-up language (XML) converter converts the defect inspection information into converted defect inspection information that is in a form defined by user defined tags. The converted defect inspection information is transmitted through a network to a defect source identifier server. Defect source information is derived at the defect source identifier server in response to the converted defect inspection information. The information can then be accessed by any client via the network and the server.

### BRIEF DESCRIPTION OF THE DRAWINGS

The teachings of the present invention can be readily understood by considering the following detailed description in conjunction with the accompanying drawings, in which:

FIG. 1 depicts a defect source identifier;

FIG. 2 depicts a block diagram of the defect source identifier shown in FIG. 1;

FIGS. 3A and 3B together depict a flowdiagram for a request transaction method;

FIG. 4 depicts a signal sequence diagram for the request transaction method of FIGS. 3A and 3B;

FIGS. 5A and 5B together depict a flowdiagram for a data notification transaction method; and

FIG. 6 depicts a signal diagram of the data notification transaction method of FIGS. 5A and 5B.

To facilitate understanding, identical reference numerals have been used, where possible, to designate identical elements that are common to the figures.

### DETAILED DESCRIPTION

A. Defect Source Identifier Structure

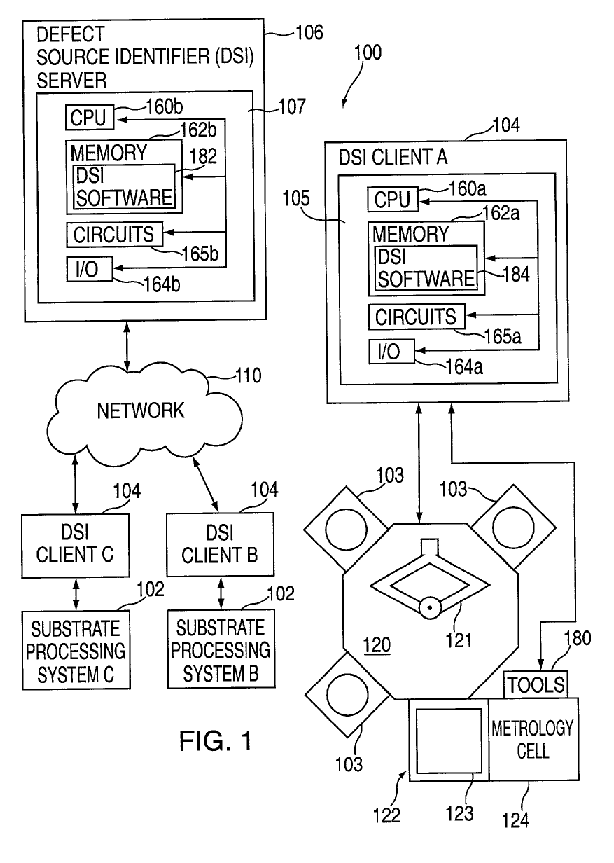

One embodiment of a defect source identifier 100 is shown in FIG. 1 that identifies defect sources in the wafers processed by a wafer processing system 102. One co-pending application that discloses one embodiment of the defect source identifier 100 is shown in U.S. patent application Ser. No. ______, filed ______ (Attorney Docket 4748 FET/MDR), which is incorporated herein by reference. The defect source identifier 100 comprises a defect source identifier server 106, a network 110, and a plurality of defect source identifier clients 104. Each defect source identifier client 104 is coupled to a wafer processing system 102. The present disclosure describes a method and apparatus for communicating images, data, and/or other information between the different networked portions within the defect source identifier 100. The wafer processing system 102 includes one or more process cells 103. Each one of the process cells is configured to perform such processes on wafers as chemical vapor deposition (CVD), physical vapor deposition (PVD), electro-chemical chemical plating (ECP), electroless deposition, other known deposition processes, or other known etching processes.

The defect source identifier 100 analyzes defects to identify sources of defects that have occurred in wafers during processing within the wafer processing system 102. The defect source identifier 100 transfers wafer data, images, and/or information relating to the wafer defects to a remote location for analysis, compares wafer images to case histories of wafer defects, perform spectral analysis on the wafer, and/or transfer defect sources and operational solutions to defects to the wafer processing system (or to an operator located at the wafer processing system). The defect source identifier 100 analyzes defect sources in the operation of and/or the states of one or more of the process cells as evidenced by defects in the wafers that have been processed within the process cells as well as the operating states of the process cells. Wafers that may undergo processing in process cells include semiconductor wafers or some other form of substrate upon which sequential process steps are performed.

More specifically, the embodiment of defect source identifier 100 shown in FIG. 1 comprises one or more defect source identifier clients 104, one or more defect source identifier servers 106, and a network 110. Each of the clients 104 are coupled to a wafer processing system 102. The wafer procession systems 102 comprise a transfer cell 120, a plurality of process cells 103, a wafer transfer system 121 (also referred to as a robot), and a factory interface 122. The factory interface 122 includes a cassette load lock 123, a metrology cell 124, and metrology tools 180. The cassette load lock 123 stores one or more wafer cassettes. Metrology tool(s) 180 are directed at, and associated with, the metrology cell 124 to measure and test the wafer characteristics and wafer defects in an effort to detect wafer defect sources. The metrology tools 180 may include, e.g., a scanning electron microscope process, an optical wafer defect inspection system process, a spatial signature analysis device, wafer defect analyzers, transmission electron microscope, ion beam analyzers, and/or any metrology tool used to analyze wafers defects.

A plurality of defect source identifier clients 104 are shown in the embodiment of FIG. 1 as defect source identifier clients A, B, and C. The following description references the defect source identifier client A, but is representative of all of the defect source identifier clients. The defect source identifier client 104 includes a client computer 105 that controls the operation of both the wafer processing system 102 including the individual process cells 103. The defect source identifier server 106 includes the server computer 107.

The client computer 105 interacts with the server computer 107 via network 110 to receive data stored in the server computer 107 that relates to present and historical (i.e., case study) defects on wafers processed by the wafer processing system 102. As such, the client computer 105 and the server computer 107 interact with one or more of the metrology tools 180 (and a variety of databases that store wafer defect case histories) to analyze defect generation in the wafer processing system 102. The network 110 provides data communications between the client computer 105 and the server computer 107. The network 110 may utilize the Internet, an intranet, a wide area network (WAN), or any other form of a network. It is envisioned that the network 110 may utilize such computer languages as Hypertext Markup Language (HTML) or eXtensible Markup Language (XML) that are utilized by the network 110. HTML is presently the predominant markup language utilized by the Internet. XML is a markup language that is gaining greater acceptance in the Internet. The use of HTML and/or XML requires the use of a respective HTML and/or XML browser installed at each client computer 105.

HTML and XML both utilize tags to define the types and contents of transmitted data. For example, images will be tagged differently from text in both HTML and XML. HTML provides approximately 100 tags that are defined by the language. XML allows for the user, or system operator, to define as many unique tags as desired and necessary. XML's unlimited number of user-defined tags are suited to use in the defect source identifier 100 and the defect knowledge library database system because many different data types between different users can be transmitted between the wafer processing system 102, the defect source identifier client 104, the network 110, and the defect source identifier server 106.

The defect source identifier client 104 and the defect source identifier server 106 interact with the wafer processing system 102 to identify defects for processed semiconductor wafers. The defect source identifier client 104 and the defect source identifier server 106 provide solutions to the wafer defects. The operation of the wafer processing system 102 is controlled by a particular defect source identifier client 104. In certain embodiments of defect source identifier 100, the defect source identifier client 104 receives derived solutions from the defect source identifier server. The solutions are applied to the wafer processing system 102 (either automatically or input from an operator), and the solutions are used to control the operation of the wafer processing system.

Since the operation and function of the client computer 105 and the server computer 107 are so closely integrated, similar client/server operations can be performed by either the client computer 105 or the server computer 107. In this disclosure the reference number of elements in the client computer 105 are appended with an additional reference character “a”. In a similar manner, the reference characters of the server computer 107, are appended with an additional reference character “b”. In sections of the disclosure where it is important to differentiate the elements of the client computer 105 from the elements of the server computer 107, the suitable respective reference character “a” or “b” is provided. In sections of the disclosure that either or both of an element of the client computer 105 or a server computer 107 can perform the prescribed task, the appended letter following the reference character may be omitted.

The respective client computer 105 and server computer 107 comprise a respective central processing unit (CPU) 160a, 160b; a memory 162a, 162b; support circuits 165a, 165b; an input/output interface (I/O) 164a, 164b; and a bus. The client computer 105 and the server computer 107 may each be fashioned as a general-purpose computer, a microprocessor, a workstation, microcontroller, a personal computer (PC), an analog computer, a digital computer, a microchip, a microcomputer, or any other known suitable type of computing device or system. The CPU 160a, 160b performs the processing and arithmetic operations for the respective client computer 105 and server computer 107.

The memory 162a, 162b includes random access memory (RAM), read only memory (ROM), removable storage, disk drive storage, that whether singly or in combination store the computer programs e.g., DSI software 182 or 184, operands, operators, dimensional values, wafer process recipes and configurations, and other parameters that control the defect source identification process and the wafer processing system operation. Each bus in the client computer 105 or the server computer 107, not shown, provides for digital information transmissions between respective CPU 160a, 160b; respective support circuits 165a, 165b; respective memory 162a, 162b; and respective I/O interface 164a, 164b. The bus in the client computer 105 or the server computer 107 also connects respective I/O interface 164a, 164b to other portions of the wafer processing system 102.

I/O interface 164a, 164b provides an interface to control the transmissions of digital information between each of the elements in the client computer 105 and/or the server computer 107. I/O interface 164a, 164b also provides an interface between the elements of the client computer 105 and/or the server computer 107 and different portions of the wafer processing system 102. Support circuits 165a, 165b comprise well-known circuits that are used in a computer such as clocks, cache, power supplies, other user interface circuits, such as a display and keyboard, system devices, and other accessories associated with the client computer 105 and/or the server computer 107.

The defect source identifier 100 utilizes an automated defect source identification software program, portions 182, 184 of the program are stored in the memory 162a or 162b to run respectively on the client computer 105 and the server computer 107. The defect source identifier 100 automatically derives the source of a defect and either displays the possible causes with minimal user intervention and/or automatically remedies the process situation in the wafer processing system 102 that lead to the defect. Due to the automation of certain embodiments of defect source identifier 100 (and the production of possible solutions to certain defects by referencing historical defect case information). The defect source identifier 100 reduces problem solving cycle time, simplifies the defect source identifying process, and improves defect identification accuracy.

The defect source identification software program may be organized as a network-based application that generates an executive summary screen that is functionally subdivided into a plurality of graphical user interface screen. The graphical user interface screen displays its interfaces and defect sources at the defect source identifier client 104. The users at the defect source identifier client 104 can thus interface with the defect reference system at the defect source identifier client to populate the executive summary screen. In another embodiment, the defect reference system 100 can be configured as a stand-alone alone system contained in the defect source identifier client 105. The selected configuration of the defect source identifier depends largely on the desired resulting operation and performance characteristics.

The Extensible Markup Language (XML) is a standardized markup language that is utilized to provide Internet and other network based communications. In one embodiment of defect source identifier 100, XML is selected as the protocol for data transfer between the defect source identifier client 104 and the defect source identifier server 106. XML uses user-defined tags to support data transfer of a variety of data types from one network node to another network location node. XML supports the use of a large number of predefined tags, and non-predefined tags. The use of a large number of tags allows the specific content of each portion of an XML data structure to be more clearly defined. XML can separate and organize data transferred based on the content of the data as defined by the tags. For example, multiple images plus alignment data describing the location of each image can be transferred in a single XML file. The images can thus be removed utilizing the alignment data using data processing techniques. XML is designed to be platform independent so users of different operating systems can utilize the defect source identifier 100.

Additionally, XML provides for extended linking and advanced addressing in which multiple destination sites are selected from a single link. This extended linking function can simplify accessing multiple and varied linked sites depending upon the user input, skill, or selected output such that data can be accessed at multiple, geographically dispersed locations simultaneously. As such, the various servers 106 and clients 104 form a large, distributed library of defect, defect source and defect solutions.

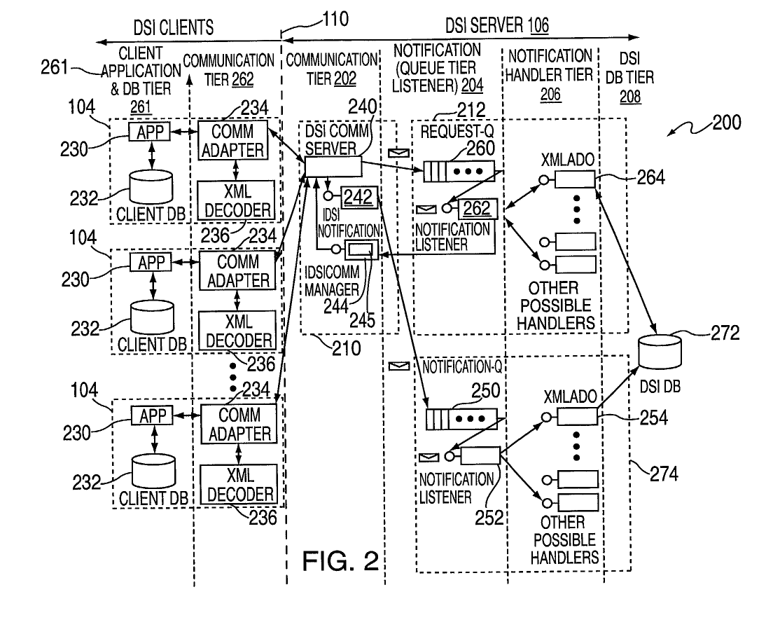

One embodiment of communication between the defect source identifier client 104 and the defect source identifier server 106 utilizes TCP socket based communication. In the TCP protocol, the entire address of a source or destination node is called a socket. The socket for each node is organized hierarchically including network ID, host ID, and user or process ID. One embodiment of data transfer within the defect source identifier 100 could be implemented as indicated in FIG. 2. Alternatively, hardware elements could be used for portions of the defect source identifier 100 to facilitate communications between servers 106 and clients 104. The following description of FIG. 2 should be considered in view of FIG. 1.

The diagram of FIG. 2 shows the software architecture 200 of the defect source identifier 100. The defect source identifier server 106 can be divided into 4 tiers including a communication tier 202, a notification queue tier 204, a notification handler tier 206, and a database tier 208. The defect source identifier server 106 can also be subdivided into three processes including a communication process 210, a receive queue process 212, and a transmit queue process 214. The communication process 210 includes WINDOWS NT® service applications for managing socket communication and sending notification to proper message queues. The receive queue process 212 and the transmit queue process 214 can both include either a MICROSOFT® Transaction Server or WINDOWS NT® service applications. The receive queue process 212 and the transmit queue process 214 are both configured to perform notification listener and handler action. The receive queue process 212 is provided for data request and the transmit queue process 214 is provided for data notification. Separation of the two kinds of message processes into distinct queue processes 212 and 214 enhances data storage and transfer performance. Data notification usually happens more frequently and involves transfer of data of a larger size than data request. Therefore, the queue process 214 that is primarily associated with data requests will have a lower volume of data transfer traffic than the transmit queue process 212 that is primarily associated with the data notification.

The software architecture of the defect source identifier client 104 may vary depending on the application of the defect source identifier 100. The defect source identifier client 104 typically includes a plurality of defect source identifier clients 104. Each defect source identifier client 104 includes a client database 232, a client application 230, a communication adapter 234, and an XML decoder 232.

The architecture of the defect source identifier client 104 typically includes an application and database tier 261 and communication tier 262. The application and database tier 261 comprises the client application 230 and a client database 232. The client application 230 interacts with the client database 232 to controllably access, or store, data respectively from, or to, the client database 232. The communication adapter 234 acts as an I/O portion to transmit data between a client application 230, the XML decoder 236, and communications tier 202 of the defect source identifier server 106.

The communication tier 262 comprises the communication adapter class 234 and the XML decoder class 236. The communication adapter class 234 is provided for handling socket communication with the defect source identifier client 106.

The XML decoder class 236 is provided for translating between XML (that is the protocol for data being transmitted between defect source identifier client 104 and the defect source identifier server 106) and the language used by the client application 230. The XML decoder class 236 effects data translation of data packets not following the XML format by wrapping, and unwrapping, the non-XML data packets utilizing XML parsing of the application packets based on using an XML C++ parser and a SAX® (model (a trademark of Meggison Technologies, Ltd. Of Ottowa, Ontario Canada). SAX® is a standard, commercially available, interface for event-based XML parsing and acts as a simple application programming interface for XML. The XML decoder class 236 translates data and other information that is typically stored in the client database 232, or in another format such as WINDOWS®, into an XML format. The data stored in XML format can be efficiently and reliably conveyed over the Internet or another networks.

The communication adapter 234 of the defect source identifier client 104 typically includes a browser such as NETSCAPE NAVIGATOR® or Microsoft's INTERNET EXPLORER® that enables the defect source identifier client 104 to interface with the network 110. The process 210 includes communication server 240, a notification device 242, and a communication manager 244. The transmit queue process 214 includes a notification queue 250, a notification listener 252, a plurality of handlers 254, including, e.g., and an XML Active X Data Object (ADO) 254. The XML ADO 254 acts as a high level interface between the defect source identifier database 272 and the notification queue 250. The XML ADO 254 is used to retrieve data from defect source identifier database 408. The transmit queue process 214 briefly stores information, such as packets or other data, being transmitted from the process 210 to be stored in the defect source identifier database 272.

The request queue process 212 includes a request queue element 260, a notification listener 262, and at least one XML ADO 264. The request queue process 212 acts to temporarily store information, such as packets and other data, stored in the defect source identifier database 272 to be forwarded to the process 210. This information is typically forwarded to the process 210 for the purpose of further transmission to one the defect source identifier client 104.

While two distinct processes are shown by the request queue process 212 and the notification queue process 214, it is envisioned that the process 212 and the transmit queue process 214 may be physically incorporated in a single queue process. Such a unified queue process acts to merge the queue activities of queuing processes 212 and 214 to provide for temporary storage and transmission of information such as packets or other data in both respective directions between the defect source identifier client 104 and the defect source identifier server 106.

The four tiers 202, 204, 206, and 208 included in the defect source identifier server 106 are now described in detail. The communication tier 202 manages the low level network communication between, and provides an interface between, the defect source identifier clients 104 and the defect source identifier server 106. One embodiment of the communication tier 202 has implemented a WINDOWS® NT service communication server 240 for managing TCP based socket communication between the defect source identifier clients 104 and the defect source identifier server 106. The communication tier 202 includes a communication manager 244 that provides a socket-based communication interface between the defect source identifier clients 104 and the defect source identifier server 106. The communication manager 244 allows a defect source identifier server 106 application to send a reply back to the defect source identifier clients 104 utilizing the socket opened for this connection.

One embodiment of the communication interface of the communication manager 244 includes a socket server 245. The socket server 245 acts in multithreading mode to allow the concurrent performance of multiple tasks. Whenever the socket server 245 receives a new connection request for a defect source identifier client 104 directed to a defect source identifier server 106, a socket server 245 included in the communication manager 244 will spawn a new thread. The socket server also creates a new socket object to handle the communication inside the thread. When the defect source identifier client 104 terminates the connection, the socket server in the communication manager 244 closes the socket to terminate the thread. The defect source identifier notification class 242 of the communication tier 202 instantiates the defect source identifier notification interface that performs the task of sending the notification to the proper message queue.

The notification queue tier 204 includes one or a plurality of queue processes 212 and 214. The respective queue processes 212 and 214 include respective queues 250 or 260 for containing the notification messages sent between different defect source identifier clients 104 and the defect source identifier server 106. Each queue 250 or 260 is associated with a respective notification listener interface 252 or 262. Whenever a new message is added to one of the queue 250 or 260, the Arrived( ) method of the respective notification listener interface 2522 or 262 is called. Caling the queue 250 or 260 acts to detach a message from the respective queue 250, 260. Inside the Arrived( ) method, different notification listener interfaces 252 or 262 can be instantiated for processing the notification.

Each queue process 212 or 214 can be started or stopped anytime. The queue name defining each queue 250 or 260 to which the notification listener 252 or 262 is listening can be specified at runtime. This runtime operation gives the flexibility to use the same interface for different use cases (the wafer defect inspection process 204 the manufacturing execution database process 210, etc.). The notification queue tier 204 performs the notification listening and notification handling tasks for the defect source identifier server 106. The notification handling tasks are varied from adding/retrieving records for the defect source identifier database to requesting data from a remote tool such as a metrology tool 180.

In one embodiment of queue process 212 and 214, the connectionID class is decoded from the notification label, and the request data is decoded from the notification body. The connectionID is decoded from the notification label by calling the defect source identifier requests method of the XML ADO interface 250 or 264. The request data is decoded from the notification body by passing in the request data (in XML) and get the reply data (in XML). The communication manager 244 calling a SendStringToConnection( ) method to send the reply to defect source identifier client via the same connectionID, using the same socket.

The notification handler tier 206 can either be implemented in a single-thread blocking mode or a multi-thread non-blocking mode. If the notification handler tier 206 is implemented in the multi-thread non-blocking mode, then a new message will be generated to spawn a new thread for processing the notification message. Such use of a new thread increases the efficiency of the notification listener 252 or 262. The transfer of data retrieved/added/deleted from the different defect source identifier clients 104 is synchronized to limit data interferences. The single thread blocking mode has the advantage of eliminating such data interferences to be totally thread-safe for each transaction including distinct defect source identifier clients.

The defect source identifier database tier 208 includes the defect source identifier database 408. The defect source identifier database tier 208 may be implemented using typical databases, e.g., using SQL.

The interface between the defect source identifier and a wafer defect inspection process executed by a metrology tool is based on socket intercommunication protocol. The wafer defect inspection process and the defect source identifier transfer data through a prescribed socket. The defect source identifier client 104 initiates communication. The defect source identifier client 104 opens a socket and sends the data, using the socket, to the defect source identifier server 106. The defect source identifier server 106 runs multiple concurrent processes such as provided by Windows NT® processes including listening to sockets, performing ADO, and the like.

Using XML as a data format protocol in the defect source identifier 100 allows the data content to be separated into different types (e.g. images, data, or other information types) using data processing techniques. Additionally, XML is platform-independent. As such, the defect source identifier clients utilizing different operating systems can all interact on the network 110 with a single detect source identifier server 106. The defect source identifier 100 can implement a generic interface to deal with common tasks, and each distinct user can add different user-defined data decoder capabilities based on the desired request/reply parameters without changing the generic common task framework.

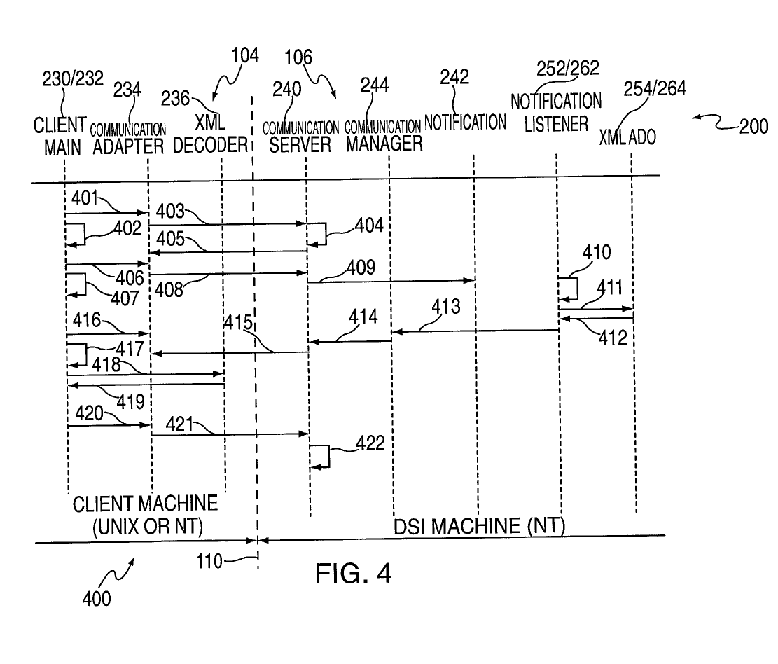

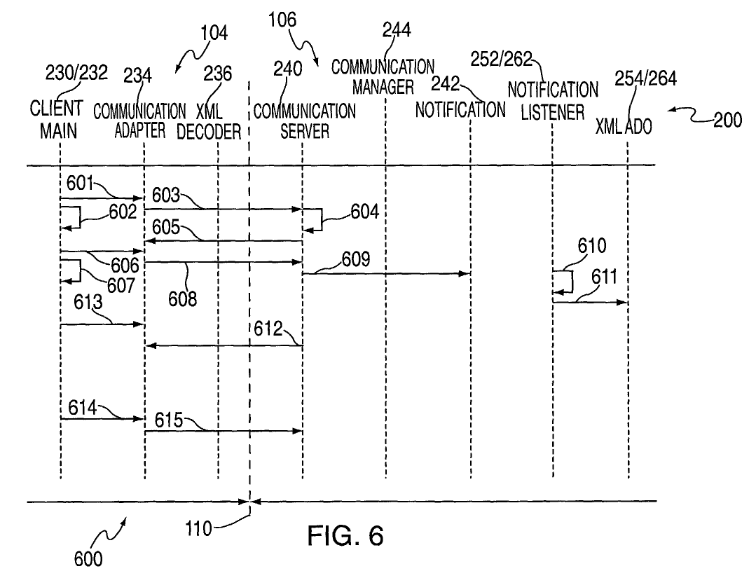

A variety of public member function embodiments are now described. These public member functions relate to the embodiment of defect source identifier request transaction 400 shown in FIG. 4 and/or the embodiment of defect source identifier notification transaction 600 shown in FIG. 6. Two classes, a DSIConnector class and an XMLDataDecoder class are defined by a wafer defect inspection process of the metrology tools 180, that can be used by main applications when the defect source identifier starts data request transaction with the defect source identifier server 106.

The DSIConnector class is one embodiment of a standalone class which establishes socket communication between the defect source identifier client 104 and the defect source identifier server 106. The following public member functions are provided for the DSIConnector Class.

The DSIConnector function in the DSIonnector class is the DsiConnector constructor function that passes the port number and the address of the defect source identifier server 106 to the defect source identifier client 104 when creating the DSIConnector object. The address can either take the form of a name or an IP address.

The init function of the DSIConnector class initializes the DSIConnector object. The init function creates the socket ID and initializes the socket address data structure. The socket may be created in either blocking or non-blocking modes. The init function should be called right after the DSIConnector object is created. The init function indicates if there is an error.

The connect function of the DSIConnector class establishes connection between the defect source identifier client 104 and the defect source identifier server 106. The connect function attempts to connect to the defect source identifier server 106 within the time specified. This function indicates if there is an error, or if the function has timed out.

The sendRequest function of the DSIConnector class sends a request from the defect source identifier client to the defect source identifier server. The sendRequest function also creates the header. This function also indicates if the request string cannot be sent within the time specified, or if there is an error.

The getReplyHeader function of the DSIConnector class gets the reply header from the defect source identifier server 106. The message header specifies the size of the message body. The getReplyHeader function should be called before calling the getReplyBody function, so that the user can allocate sufficient memory to store the reply. The getReplyHeader function indicates if the header cannot be received within the time or if an error occurs.

The getReplyBody function of the DSIConnector class gets the reply message body from the defect source identifier server 106. The reply buffer to the getReplyBody function should be sufficient (call getReplyHeadero function to determine the body size) to hold the reply from the defect source indentifier server 106. The getReplyBody function indicates if the “complete” reply cannot be received within the time specified, or if there is an error.

The disconnect function of the DSIConnector class disconnects socket communication to the defect source identifier server 106. The disconnect function will close the socket connection, and is called when communication is no longer needed to the server.

The XMLDataDecoder class is one embodiment of a wrapper class for the XML parser in the embodiment of XML decoder 236 shown in FIG. 2. The XMLDataDecoder class runs the XML parser. As such, the XML Data Decoder class acts to translate files containing images, data and/or other information between a format that the client applications use and XML. The XML Data Decoder class contains the following public member functions:

The CWFXMLDataDecoder function is a constructor for the SMLDataDecoder class that creates instances of the data decoder class. The CWFXMLDataDecoder function includes no parameters.

The Init function for the XMLDataDecoder class initializes an object of the XMLDataDecoder class. The Init function should be called after the object is created. The Init function returns true if the object has been created.

The ParseXML function for the SMLDataDecoder class parses the XML string format.

The public member data for the XMLDataDecoder class includes the document handler for the SAX parser. The decoded data is stored as a public member data of CWFSAXHandler.

To save runtime performance and data traffic across the network 110, the standard XML format (which was more parsing-flexible) is modified. The XML format for defect source identifier client data request is utilized. Maintaining an attribute name-type table and an element name-type table in each side is desired. Therefore a data type does not need to be attached for each instance of a data item every time. Instead, one embodiment of the defect source identifier uses the two lookup tables to fetch the type by name at runtime. The new format also introduces multiple attributes in one element to save data flow size.

One embodiment of the generic XML string for data request includes the pseudocode:

<DSINotificationXML
<Header To=“$To”
From=“$From”
Type=“Request”
Name=“$Name” />
<Data>
...
</Data>
</DSINotificationXML>

The XML attributes and elements of the generic data request class are shown in TABLE 1.

TABLE 1
Generic Data Request Class

| | | XML | |
|---|---|---|---|
| Name | Parent | Type Class | Description |
| DSINotificationXML | None | Element | Composite data structure for containing all input parameters |
| Header | DSINotificationXML | Element | Composite data structure for containing input data header |
| To | Header | Attribute | Input parameter that is the machine name where the request comes to. |
| From | Header | Attribute | Input parameter that is the machine name where the request comes from. |
| Type | Header | Attribute | Input parameter that specify the message type, which is one of following: |
| | | | Request |
| | | | Reply |
| | | | Notification |
| Name | Header | Attribute | Input parameter that specify the message name, which is one of following: |
| | | | GetLeadClasses |
| | | | GetReviewed WaferList |
| Data | DSINotificationXML | Element | Composite data structure for containing input data body |

One embodiment of the generic XML string for data reply includes the pseudocode:

<DSINotificationReplyXML>
<Header To=“$To”
From=“$From”
Type=“Reply”
Name=“$Name” />
<Data>
<Error ErrNum=“$ErrNum”
ErrText=“$ErrText” />
<ReplyDataList>
<ReplyData />
... ...
<ReplyData />
</ReplyDataList>
</Data>
</DSINotificationReplyXML>

In the above pseudocode, the string “$xxx” separates the value of the data item. TABLE 2 describes the XML attributes and elements included in the generic data reply class.

TABLE 2
Generic Data Reply Class

| Name | Parent | XML Type | Description |
|---|---|---|---|
| DSINotificationReplyXML | None | Element | Composite data structure for containing all output parameters |
| Header | DSINotificationReplyXML | Element | Composite data structure for containing input data header |
| To | Header | Attribute | Output parameter that is the machine name where the reply |
| | | | comes to. |
| From | Header | Attribute | Output parameter that is the machine name where the reply |
| | | | comes from. |
| Type | Header | Attribute | Output parameter that specify the message type, which is one of |
| | | | following: |
| | | | Request |
| | | | Reply |
| | | | Notification |
| Name | Header | Attribute | Output parameter that specify the message name, which is one of |
| | | | following: |
| | | | GetLeadClasses |
| | | | GetReviewedWaferList |
| Data | DSINotificationReplyXML | Element | Composite data structure for containing output data body |
| Error | Data | Element | Composite data structure for containing error data |
| ErrNum | Error | Attribute | Output parameter that specify the error number as the result of |
| | | | this action. |
| ErrText | Error | Attribute | Output parameter that specify the error text as the result of |
| | | | this action. |
| ReplyDataList | Data | Element | Composite data structure for containing output reply data list. |
| ReplyData | ReplyDataList | Element | Composite data structure for containing output reply data. |

The GetLeadClasses method will return the list of defects with lead class or the most important class for a specific defect. This method is used to determine the wafer/lots that have processed on a specific wafer defect inspection process 204 and we still have the information stored in the wafer defect inspection process 204. This method accesses images, data, or other information stored in the wafer defect inspection process to retrieve the data.

One embodiment of the XML string for data request for the GetLeadClass includes the pseudocode:

<DSINotificationXML
<Header To=“$To”
From=“$From”
Type=“Request”
Name=“GetLeadClasses” />
<Data>
<WFLST NUM=“$TOTAL_WAFER_NUMS”
MDPC=“$MaxDefectperClass”>
<WF PID=“$ProductID”
LID=“$LotID”
WID=“$WaferID”
SID=“$StepID” />
...
<WF PID=“$ProductID”
LID=“$LotID”
WID=“$WaferID”
SID“$StepID” />
</WFLST>
</Data>
</DSINotificationXML>

Beside the first WF data block, the rest WF data block can omit PID (Product ID) and SID (Step ID) if all wafers have the same PID and SID to save a lot of unnecessary data duplication. One embodiment of the attributes and elements at the data request string for the GetLeadClass are shown in TABLE 3.

TABLE 3
Data Request String For GetLeadClass

| Name | Parent | XML Type | Description |
|---|---|---|---|
| (WFLST) | Data | Element | Composite data |
| WaferIDList | | | structure for contain- |
| | | | ing a list of WaferIDs. |
| NUM | WFLIST | Attribute | Input parameter that is |
| | | | the total number of |
| | | | wafers in the list |
| MDPC | WFLIST | Attribute | Input parameter that |
| (MaxDefectPerClass) | | | indicate the upper limit |
| | | | of defect to retrive, if |
| | | | MaxDefectPerClass is |
| | | | 20 we would like to |
| | | | get not more that 20 |
| | | | records that has the |
| | | | same classID. If |
| | | | MaxDefectPerClass is |
| | | | −1 there is no limits. |
| WF | WFLST | Element | Composite data |
| | | | structure for contain- |
| | | | ing WF information |
| PID | WF | Attribute | Input parameter that is |
| (ProductID) | | | the unique identifier of |
| | | | the Product. |
| LID (LotID) | WF | Attribute | Input parameter that is |
| | | | the unique identifier of |
| | | | the lot. |
| WID (WaferID) | WF | Attribute | Input parameter that is |
| | | | unique identifier the |
| | | | wafer to collect defect |
| | | | data on. |
| SID (StepID) | WF | Attribute | Input parameter that is |
| | | | the unique identifier of |
| | | | the step/layer. |

One embodiment of the XML string for data reply for the GetLeadClass includes the pseudocode:

<DSINotificationReplyXML>
<Header To=“$To”
From=“$From”
Type=“Reply”
Name=“GetLeadClasses” />
<Data>
<Error ErrNum=“$ErrNum”
ErrText=“$ErrText” />
<ReplyDataList>
<WF_DFT NUM=“$TOTAL_DEFECTS_NUMS”
PID“$ProductID”
LID=“$LotID”
WID=“$WaferID”
SID=“$StepID” >
<DFT DID=“$DefectID”
CID=“$ClassID”
CN=“$ClassName”
SRC=“$Source”
TM=“$ToolModel”
TID=“$ToolID”
SSA=“$SSAID” />
<DET DID=“$DefectID”
CID=“$ClassID”
CN=“$ClassName”
SRC=“$Source”
TM=“$ToolModel”
TID=“$ToolID”
SSA=“$SSAID” />
</WF_DFT>
...
<WF_DFT NUM=“$TOTAL_DEFECTS_NUMS”
PID=“$ProductID”
LID=“$LotID”
WID=“$WaferID”
SID=“$StepID”>
<DFT DID=“$DefectID”
CID=“$ClassID”
CN=“$ClassName”
SRC=“$Source”
TM=“$ToolModel”
TID=“$ToolID”
SSA=“$SSAID” />
... ...
<DFT DID=“$DefectID”
CID=“$ClassID”
CN=“$ClassName”
SRC=“$Source”
TM=“$ToolModel”
TID=“$ToolID”
SSA=“$SSAID” />
</WF_DFT>
</ReplyDataList>
</Data>
</DSINotificationReplyXML>

Beside the first WF_DFT data block, the rest WF_DFT data block can omit PID and SID if all wafers have the same PID and SID to save unnecessary data duplication.

One embodiment of the attributes and elements of the data request string for the GetLeadClass is defined in TABLE 4 as follows:

TABLE 4
Data Request String for GetLeadClass

| Name | Parent | XML Type | Description |
|---|---|---|---|
| WF_DFT | ReplyDataList | Element | Composite data structure for containing output reply data. |
| (DEFECTS_PER_WAFER) | | | |
| NUM | WF_DFT | Attribute | Output parameter that is the total number of defects in this wafer. |
| (NumOfTotalDefectsInThisWafer) | | | |
| PID (ProductID) | WF_DFT | Attribute | Output parameter that is the unique identifier of the Product. |
| LID (LotID) | WF_DFT | Attribute | Output parameter that is the unique identifier of the lot. |
| WID (WaferID) | WF_DFT | Attribute | Output parameter that is unique identifier the wafer to collect defect |
| | | | data on. |
| SID (StepID) | WF_DFT | Attribute | Output parameter that is the unique identifier of the step/layer. |
| DFT (DEFECT) | WF_DFT | Element | Composite data structure for containing output reply data. |
| DID (DefectID) | DFT | Attribute | Output parameter for defect ID |
| CID (ClassID) | DFT | Attribute | Output parameter for defect class as define in the result file |
| CN (ClassName) | DFT | Attribute | Output parameter for defect class name as define in the result file |
| SRC (Source) | DFT | Attribute | Output parameter for the source of the classification can be “MAN” for |
| | | | MAN-ADC, “ADC” for scanning electron microscope-automated |
| | | | defect classification, “OPT” for optic and “FIB” for FIB classes. The |
| | | | order of important will be configure in the defect source identifier |
| | | | configuration screen. The default order is MAN, ADC, OPT if not from |
| | | | WF. |
| TM (ToolModel) | DFT | Attribute | Output parameter for the tool model. |
| TID (ToolID) | DFT | Attribute | Output parameter for the tool ID |
| SSA (SsaID) | DFT | Attribute | Output parameter for the SSA class of the defect |
| ErrNum | Error | Attribute | Output parameter for Error number |
| ErrText | Error | Attribute | Output parameter for Error description |

The GetReviewedWaferList method returns a list of wafers that belong to a specific lot and have reviewed on a scanning electron microscope process. This method is used to determine the wafers that have processed on a specific scanning electron microscope process and we still have the information in the scanning electron microscope process. This method accesses the scanning electron microscope process in order to retrieve the data. PATENT

One embodiment of the XML string for data request for the GetReviewedWaferList class includes the pseudocode:

<DSINotificationXML
<Header To=“$To”
From=“$From”
Type=“Request”
Name=“GetReviewedWaferList ” />
<Data>
<WFLST NUM=“$TOTAL_WAFER_NUMS”>
<WF PID=“$ProductID”
LID=“$LotID”
WID=“$WaferID”
SID=“$StepID” />
...
<WF PID=“$ProductID”
LID=“$LotID”
WID=“$WaferID”
SID=“$StepID” />
</WFLST>
</Data>
</DSINotificationXML>

Beside the first wafer defect inspection process data block, the rest wafer defect inspection process data block can omit PID and SID if all wafers have the same PID and SID to save a lot of unnecessary data duplication. TABLE 5 shows one embodiment of the attributes and elements for data request storing in The GetReviewed Wafer List Class.

TABLE 5
Data Request Storing for GetReviewedWaferList Class

| Name | Parent | XML Type | Description |
|---|---|---|---|
| (WFLST) | Data | Element | Composite data structure for |
| WaferIDList | | | containing a list of WaferIDs. |
| NUM | WFLIST | Attribute | Input parameter that is the total |
| | | | number of wafers in the list |
| WF | WFLST | Element | Composite data structure for |
| | | | containing WF information |
| PID | WF | Attribute | Input parameter that is the |
| (ProductID) | | | unique identifier of the Product. |
| LID (LotID) | WF | Attribute | Input parameter that is the |
| | | | unique identifier of the lot. |
| WID | WF | Attribute | Input parameter that is unique |
| (WaferID) | | | identifier the wafer to collect |
| | | | defect data on. |
| SID (StepID) | WF | Attribute | Input parameter that is the |
| | | | unique identifier of the |
| | | | step/layer. |

One embodiment of the XML string for data reply for the GetReviewedWaferList class includes the pseudocode:

<DSINotificationReplyXML>
<Header To=“$To”
From=“$From”
Type=“Reply”
Name=“GetReviewedWaferList ” />
<Data>
<Error ErrNum=“$ErrNum”
ErrText=“$ErrText” />
<ReplyDataList NUM=“$NUM_OF_WAFERS”>
<WAFER WID=“$WaferID”
LID=“$LotID”
PID=“$ProductID”
SID=“$StepID”
RV=“$Reviewed”
S EM=“$SEMToolID”
RCP=“$RecipeName”
UTM=“$UpdateTime” />
... ...
<WAFER WID=“$WaferID”
LID=“$LotID”
PID=“$ProductID”
SID=“$StepID“
RV=“$Reviewed”
SEM=“$SEMToolID”
RCP=“$RecipeName”
UTM=“$UpdateTime” />
</ReplyDataList>
</Data>
</DSINotificationReplyXML>

TABLE 6
Data Reply String for GetReviewedWaferList Class

| Name | Parent | XML Type | Description |
|---|---|---|---|
| NUM (NumOfTotalWafers) | ReplyDataList | Attribute | Output parameter that is the number of total number of wafers |
| WAFER | ReplyDataList | Element | Composite data structure for containing output reply data. |
| WID (WaferID) | WAFER | Attribute | Output parameter that is the unique identifier of the wafer. |
| LID (LotID) | WAFER | Attribute | Output parameter that is the unique identifier of the lot. |
| PID (ProductID) | WAFER | Attribute | Output parameter that is the unique identifier of the Product. |
| SID (StepID) | WAFER | Attribute | Output parameter that is the unique identifier of the step/layer. |
| RV (Reviewed) | WAFER | Attribute | Output parameter that identifies if the wafer is reviewed or not. |
| SEM (SEMToolID) | WAFER | Attribute | Output parameter that is the unique identifier of the SEMTool. |
| RCP (RecipeName) | WAFER | Attribute | Output parameter for the recipe name on the SEMTool. |
| UTM (UpdateTime) | WAFER | Attribute | Output parameter for wafer last update time. |
| ErrNum | Error | Attribute | Output parameter for Error number |
| ErrText | Error | Attribute | Output parameter for Error description |

The following methods are used to marshal data from the wafer defect inspection process to the defect source identifier database. The wafer defect inspection process will be a client which use those methods to populate the defect source identifier database with all wafers and defect data.

One embodiment of the generic XML string for data notification includes the pseudocode:

<DSINotificationXML
<Header To=“$To”
From=“$From”
Type=“xxx_Notification”
Name=“$Name” />
<Data>
...
<Data>
</DSINotificationXML>

TABLE 7
Generic XML String for Data Notification Class

| Name | Parent | XML Type | Description |
|---|---|---|---|
| DSINotificationXML | None | Element | Composite data structure for containing all input parameters |
| Header | DSINotificationXML | Element | Composite data structure for containing input data header |
| To | Header | Attribute | Input parameter that is the machine name where the request comes to. |
| From | Header | Attribute | Input parameter that is the machine name where the request comes from. |
| Type | Header | Attribute | Input parameter that specify the message type, which is “xxx_Notification” |
| Name | Header | Attribute | Input parameter that specify the message name, which is one of following: |
| | | | SetDieList |
| | | | SetDefectList |
| | | | SetProduct |
| Data | DSINotificationXML | Element | Composite data structure for containing input data body |

The SetDieList method sets the list of dies. For each die that defines as flash. For each die we will get the number of defects. One embodiment of the XML string for data notification for the SetDieList includes the pseudocode:

<DSINotificationXML
<Header To=“$To”
From=“$From”
Type=“WF_Notification”
Name=“SetDieList” />
<Data>
<DIELST NUM=“$TOTAL_DIE_NUMS”
WFTOOLID=“$WFToolID”
PID=“$ProductID”
LID=“$LotID
WID=”$WaferID”
SID=“$StepID”>
<DIEINFO XDIE=“$XDie”
YDIE=“$YDie”
FL=“$FLASH”
CT=“$Count”/>
...
<DIEINFO XDIE=“$XDie”
YDIE=“$YDie”
FL=“$FLASH”
CT=“$Count”/>
</DIELST>
</Data>
</DSINotificationXML>

TABLE 8
XML Data Notification String for SetDieList Class

| Name | Parent | XML Type | Description |
|---|---|---|---|
| (DIELST) | Data | Element | Composite data structure for |
| DIEList | | | containing a list of Dies. |
| NUM | DIELST | Attribute | Input parameter that is the total |
| | | | number of dies in the list |
| WFTID | DIELST | Attribute | Input parameter that is the |
| (WFToolID) | | | unique identifier of WF tool in |
| | | | the list |
| PID | DIELST | Attribute | Input parameter that is the |
| (ProductID) | | | unique identifier of the Product. |
| LID (LotID) | DIELST | Attribute | Input parameter that is the |
| | | | unique identifier of the lot. |
| WID | DIELST | Attribute | Input parameter that is unique |
| (WaferID) | | | identifier the wafer to collect |
| | | | defect data on. |
| SID (StepID) | DIELST | Attribute | Input parameter that is the |
| | | | unique identifier of the |
| | | | step/layer. |
| DIEINFO | DIELST | Element | Composite data structure for |
| (DieInfo) | | | containing DIE information |
| XDIE | DIEINFO | Attribute | Input parameter that is the X |
| (XDie) | | | size of Die. |
| YDIE | DIEINFO | Attribute | Input parameter that is the Y |
| (YDie) | | | size of Die. |
| FL (Flash) | DIEINFO | Attribute | Input parameter that specifies |
| | | | whether flashed or not |
| CT (Count) | DIEINFO | Attribute | |

The SetDefectList method sets the list of defects for given wafer/step. One embodiment of the XML string for data notification of the SetDefectList is:

<DSINotificationXML
<Header To=“$To”
From=“$From”
Type=“WF_Notification”
Name=“SetDefectList ” />
<Data>
<DFLST NUM=“$TOTAL_DF_NUMS”
WFTOOLID=“$WFToolID”
PID=“$ProductID”
LID=“$LotID
WID=“$WaferID”
SID=“$StepID”
FLF=“$FromFlashDieOrNot”>
<DF DID=“$DefectID”
XDIE=“$XDie”
YDIE=“$YDie”
XL=“$XLocation”
YL=“$YLocation”
XS=“$XSize”
YS=“$YSize”
DS=“$DSize”
OAID=“$OTFADCID”
OCID=“$OpticalClassificationID”
INUM=“$NumImages”
IPH=“$ImagePath”
CL=“$Cluster”/>
...
<DF DID=“$DefectID”
XDIE=“$XDie”
YDIE=“$YDie”
XL=“$XLocation”
YL=“$YLocation”
XS=“$XSize”
YS=“$YSize”
DS=“$DSize”
OAID=“$OTFADCID”
OCID=“$OpticalClassificationID”
INUM=“$NumImages”
IPH=“$ImagePath”
CL=“$Cluster”/>
</DFLST>
</Data>
</DSINotificationXML>

TABLE 9
XML Data Notification String for SetDefectList Class

| Name | Parent | XML Type | Description |
|---|---|---|---|
| (DFLST) | Data | Element | Composite data structure |
| DefectList | | | for containing a list of |
| | | | defects. |
| NUM | DFLST | Attribute | Input parameter that is |
| | | | the total number of |
| | | | defects in the list |
| WFTID | DFLST | Attribute | Input parameter that is |
| (WFToolID) | | | the unique identifier of |
| | | | WF tool in the list |
| PID (ProductID) | DFLST | Attribute | Input parameter that is |
| | | | the unique identifier of |
| | | | the Product. |
| LID (LotID) | DFLST | Attribute | Input parameter that is |
| | | | the unique identifier of |
| | | | the lot. |
| WID (WaferID) | DFLST | Attribute | Input parameter that is |
| | | | unique identifier the |
| | | | wafer to collect defect |
| | | | data on. |
| SID (StepID) | DFLST | Attribute | Input parameter that is |
| | | | the unique identifier of |
| | | | the step/layer. |
| FLF | DFLST | Attribute | Input parameter that |
| (FromFlashDieOrNot) | | | specifies whether the |
| | | | defects are from Flash |
| | | | Die or not. |
| DF (Defect) | DFLST | Element | Composite data structure |
| | | | for containing defect |
| | | | information |
| DID (DefectID) | DF | Attribute | Input parameter that is |
| | | | the unique identifier of |
| | | | the defect. |
| XDIE (XDie) | DF | Attribute | Input parameter that is |
| | | | the X size of Die. |
| YDIE (YDie) | DF | Attribute | Input parameter that is |
| | | | the Y size of Die. |
| XL (Xlocation) | DF | Attribute | Input parameter that is |
| | | | the X location of the |
| | | | defect. |
| YL (Ylocation) | DF | Attribute | Input parameter that is |
| | | | the Y location of the |
| | | | defect. |
| XS (XSize) | DF | Attribute | Input parameter that is |
| | | | the X size of the defect. |
| YS (YSize) | DF | Attribute | Input parameter that is |
| | | | the Y size of the defect. |
| DS (Dsize) | DF | Attribute | Input parameter that is |
| | | | the D size of the defect. |
| OAID (OFTADCID) | DF | Attribute | Input parameter that is |
| | | | the unique number of the |
| | | | on-the-fly automated |
| | | | defect classification. |
| OCID | DF | Attribute | Input parameter that is |
| (OpticalClassification) | | | the unique number of the |
| | | | Optical Classification. |
| INUM (numImages) | DF | Attribute | Input parameter that is |
| | | | the number of the |
| | | | images. |
| IPH (ImagePath) | DF | Attribute | Input parameter that is |
| | | | the image path. |
| CL (Cluster) | DF | Attribute | Input parameter that |
| | | | specifies cluster. |

The SetProduct method sets the product data for given wafer/step. One embodiment of the XML string for data notification for the SetProductMethod includes the pseudocode:

<DSINotificationXML
<Header To=“$To”
From=“$From”
Type=“WF_Notification”
Name=“SetProduct” />
<Data>
<PRODUCT WFTOOLID=“$WFToolID”
PID=“$ProductID”
LID=“$LotID
WID=“$WaferID”
SID=“$StepID”
WD=“$WaferDiam”
MT=“$MarkType”
ML=“$MarkLocation”
DPX=“$DiePitchX”
DPY=“$DiePitchY”
NDX=“$NumberDieX”
NDY=“$NumberDieY”
SDX=“$StartDieX”
SDY=“$StartDieY”
GS=“$GapSize”
FSX=“$FieldSizeX”
FSY=“$FieldSizeY”
BW=“$BareWafer”
BWR=“$BareWaferRep”/>
</Data>
</DSINotificationXML>

TABLE 10
XML Data Notification String for SetProduct Class

| Name | Parent | XML Type | Description |
|---|---|---|---|
| PRODUCT | Data | Element | Composite data structure |
| (Product) | | | for containing |
| | | | PRODUCT data. |
| WFTID | PRODUCT | Attribute | Input parameter that is |
| (WFToolID) | | | the unique identifier of |
| | | | WF tool in the list |
| PID (ProductID) | PRODUCT | Attribute | Input parameter that is |
| | | | the unique identifier of |
| | | | the Product. |
| LID (LotID) | PRODUCT | Attribute | Input parameter that is |
| | | | the unique identifier of |
| | | | the lot. |
| WID (WaferID) | PRODUCT | Attribute | Input parameter that is |
| | | | unique identifier the |
| | | | wafer to collect defect |
| | | | data on. |
| SID (StepID) | PRODUCT | Attribute | Input parameter that is |
| | | | the unique identifier of |
| | | | the step/layer. |
| WD (WaferDiam) | PRODUCT | Attribute | Input parameter that |
| | | | specifies the wafer |
| | | | diameter in mm. |
| MT (MarkType) | PRODUCT | Attribute | Input parameter that |
| | | | specifies the mark type. |
| | | | “Notch” or “Flat” |
| ML | PRODUCT | Attribute | Input parameter that |
| (MarkLocation) | | | specifies the mark loca- |
| | | | tion. “UP”, “DOWN”, |
| | | | “RIGHT” or “LEFT” |
| DPX (DiePitchX) | PRODUCT | Attribute | Input parameter that is |
| | | | the Peridicity X in |
| | | | microns. |
| DPY (DiePitchY) | PRODUCT | Attribute | Input parameter that is |
| | | | the Peridicity Y in |
| | | | microns. |
| NDX | PRODUCT | Attribute | Input parameter that is |
| (NumberDieX) | | | the number of die in X |
| | | | direction. |
| NDY | PRODUCT | Attribute | Input parameter that is |
| (NumberDieY) | | | the number of die in Y |
| | | | direction. |
| SDX (StartDieX) | PRODUCT | Attribute | Input parameter that is |
| | | | the X location of die 0,0 |
| | | | in microns. |
| SDY (StartDieY) | PRODUCT | Attribute | Input parameter that is |
| | | | the Y location of die 0,0 |
| | | | in microns. |
| GS (GapSize) | PRODUCT | Attribute | Input parameter that is |
| | | | the gap between dies. |
| FSX (FieldSizeX) | PRODUCT | Attribute | Input parameter that is |
| | | | the mask X size in dies. |
| FSY (FieldSizeY) | PRODUCT | Attribute | Input parameter that is |
| | | | the mask Y size in dies. |
| BW (BareWafer) | PRODUCT | Attribute | Input parameter that |
| | | | specifies whether this is a |
| | | | bare wafer. |
| BWR | PRODUCT | Attribute | Input parameter that |
| (BareWaferRep) | | | specifies bare wafer rep. |
| | | | “ONE”, “FOUR”, |
| | | | “FILL1” |

The defect source identifier server 106 includes multiple classes that provide functionality to the defect source identifier server 106 to, e.g., maintain sockets and threads. The defect source identifier 100 uses code such as the part number identity to communicate with the defect source identifier server 106. The port number can be changed to any unique value. Embodiments of methods and parameters of such defect source identifier server 106 as are provided in XML for the communication manager 244, the queues 250 or 260, the notification interface 242, the notification listeners 252, 262, and the XML ADOs 254, 264 are:

The communication manager interface 244 of the defect source identifier server 106 includes the following methods and properties:

A SendStringToConnection method sends a string to specified connection via its connection ID. One embodiment of the syntax for the SendStringToConnection method is ErrorCode=objDSICommManager. SendStringToConnection (long IConnectionID, BSTR bstrString). The sendStringToConnection method sends a string to specified connection via its connection ID. The SendStringToConnection method includes such parameters as IConnectionID, that specifies which connection ID to transmit data. The data is passed by value. Also, the string bstrString is an input parameter that specifies the XML string to sent. This parameter is passed by value.

A TotalConnection property returns the total number of opened connections. The syntax of the TotalConnection property is ObjDSICommManager.TotalConnection. This is a get only property.

The notification interface 242 of the defect source identifier server 106 includes the following methods and properties:

A NotifyToDSI method sends a string to pre-specified queue 250 or 260. The NotifyToDSI method follows the syntax ErrorCode=objDSINotification.NotifyToDSI(BSTR NotificationText). The NotifyToDSI( ) method includes the string paramter bstrString that specifies the XML string the method is sending. The string is passed by value.

A QueName property represents the name of the queue 250 or 260 where the notification is sent This property can both be get and set. The QueName property includes the string QueName that represents the name of the queue 250 or 260.

A NotificationLabel property represents the label of the notification message. This property can both be get and set. The NotificationLabel property includes the string NotificationLabel, that represents the notification label.

The notification listener interface 252, 262 of the defect source identifier client 106 includes the following methods and parameters.

An Initialize method initializes the task to listen to the queue 250 or 260 and processes the message received at the queue 250 or 260. The Initialize( ) method follows the syntax ErrorCode=NotificationListener.Initialize(BSTR QueName). The string QueName is a parameter of the Initialize method that specifies the queue 250 or 260 it wants to listen to. The parameter QueName is passed by value. The Initialize method includes such error codes as the queue not specified, an invalid queue name is provided, creation of a message queue failed, failure of opening a message queue, advising of a failure, message queue enable notification failure, and other communication error. The Initialize method returns a return code if the intialization method succeeded.

An Uninitialize method stops the task to listen to queue 250 or 260 and process the message. The Uninitialize method follows the syntax ErrorCode=objNotificationListener.Uninitialize(BSTR QueName).

A LastNotificationLabel property represents the label of the last notification message. This property can only be get. This property includes the string NotificationLabel. NotificationLabel is the label of the last received notification.

A LastNotification property represents the last notification message. This property can only be a get. The LastNotification property includes the string LastNotification. LastNotification represents the last received notification.

An Arrived method is called automatically when a new notification message is added to the queue 250 or 260 following initialization of the queue. One embodiment of the Arrived method follows the syntax ErrorCode=objNotificationListener.Arrived(LPDISPATCH pQueue, long Icursor). The Arrived method includes the parameter LPDISPATCH pQueue that specifies the identity of the queue 250 or 260 where the message was received. The arrived method is passed by value. Another parameter of the Arrived method is ICursor that specifies the cursor of the queue 250 or 260. The ICursor parameter is passed by value.

An ArrivedError method is automatically called when there is a new notification message including an error was added to the queue 250 or 260, following the initalization of the queue 250 or 260. The ArrivedError method follows the syntax ErrorCode=objNotificationListener.ArrivedError(LPDISPATCH pQueue, long ErrorCode, long ICursor). The ArrivedError method includes the pQueue parameter LPDISPATCH that specifies the queue 250 or 260 where the message was received. Passed by value. The ArrivedError method includes the long parameter ErrorCode that specifies an error number. The ArrivedError method includes the parameter ICursor that specifies the cursor of the queue 250 or 260. LCusor is passed by value.

The XML ADO 254, 262 of the defect source identifier server 106 includes the following methods and parameters.

A DSIRequest method is automatically called when a new notification message having an error is added to the queue 250 or 260 following initalization of the queue. One embodiment of the DSIRequest method follows the syntax ErrorCode=objDSIXMLADO.DSIRequest(BSTR RequestXML, BSTR *ReplyXML). The DSIRequest method includes the parameter BSTR RequestXML that specifies the request data in XML format. The parameter BSTR RequestXML is passed by value.

Data transfer between the defect source identifier client 104 and the defect source identifier server 106 includes two basic use cases. In one use case, the defect source identifier client 104 initiates a data request transaction from the defect source identifier server 106.

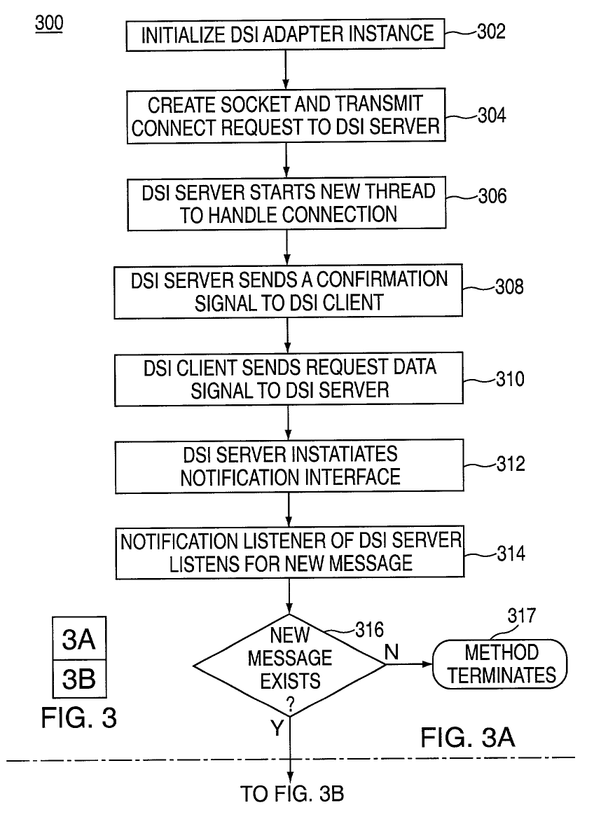

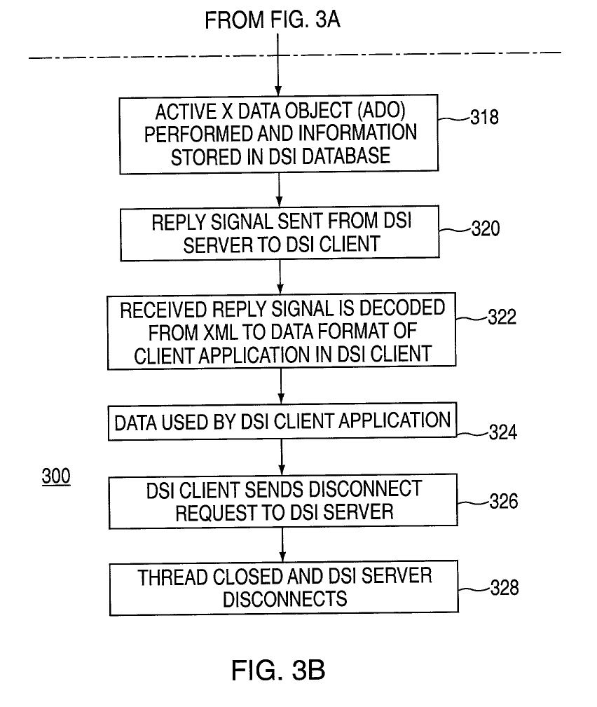

One embodiment of a signal sequence diagram of a defect source identifier request transaction 400 is shown in FIG. 4. The request transaction 400 is performed in the embodiment of defect source identifier 100 shown in FIG. 2. FIG. 3 shows a flow diagram of a data request transaction method 300 that corresponds to the signal sequence diagram of FIG. 4. FIGS. 2, 3, and 4 should be viewed together. In the defect source identifier request transaction 400, the defect source identifier client 104 initializes a defect source identifier adapter instance as shown in step 302 of FIG. 3, using the client application 230 and sends connect request signal 401 to the defect source identifier server 106.

The defect source identifier client 104 waits for returns to confirmation signals 405 by sleeping at 402 for a prescribed duration until timeout. The communication adapter 234 creates a socket and transmits a connect request signal 403 (including the socket) to the communication server 240 of the defect source identifier server 106 as shown in step 304 of FIG. 3. The communication tier 202 of the defect source identifier server listens at 404 for a new connect request. The defect source identifier client 104 starts a new thread for handling the socket as shown in step 306 of FIG. 3. The defect source identifier server 106 sends a confirmation signal 405 back to the defect source identifier client 104 as shown in step 308 of FIG. 3. After the defect source identifier client 104 is woken up by the confirmation signal 405, the client application 230 of the defect source identifier client 106 sends a request data signal 406, typically in XML format, to the communication adapter 240 of the defect source identifier server 106 in step 312 of FIG. 3. The defect source identifier client 104 waits for a send task finished indication by sleeping at 407 for a prescribed duration until a prescribed timeout.

The communication adapter 234 then sends a request data signal 408 to the communication server 240 of the defect source identifier server 106. The communication server 240 receives the request data signal 408, and transmits a separate thread 409 to the notification interface 242. The defect source identifier server 106 then instantiates the notification interface 242 and sends a message to the queue 250 (or 260) in step 312 of FIG. 3. The message includes a notification with a connection ID. The notification listener 252 or 262 listens to the respective queue 250 or 260 for a new message in step 314 of FIG. 3. If there is a new message as indicated in decision step 316 of FIG. 3, the notification listener 252 or 262 calls the respective XML ADO interface 254 or 264 (or another appropriate handler) to perform ADO and store the information in the defect source identifier database 408 in an XML format. If there is no new message, the data request transaction method 300 terminates at step 317.

To return a reply to the requested information in the request transaction 400, the ADO 264 of the defect source identifier server 106 returns an XML reply signal 412 from the defect source identifier database 408 to the respective notification listener in 412 in step 316 of FIG. 3. The XML return string in the reply signal 412 contains the reply for the requested information. The notification listener 262 calls the communication manager 244 to send the reply string back to the communication manager in 413 utilizing the connection ID. The communication manager 444 then sends the reply signal 414 to the communication server 240. The communication server 240 sends the reply signal 415 over the network 110 to the communication adapter 234 of the defect source identifier client 104 in step 320 of data request transaction method 300 shown in FIG. 3.

After the defect source identifier client 104 receives the confirmation signal 405, the client calls a GetReply( ) method in 416 that acts to fetch the reply. In 417, the defect source identifier client 104 waits for the reply signal 415 from the detect source indicator server 106 for some prescribed timeout period. After the defect source identifier client 104 receives the reply signal 415, the received XML data is transferred to the XML decoder in 418. The defect source identifier client will instantiate the XML decoder object 236 received by the XML data into the appropriate data structure, is in the data from that can be utilized by the client application 230 in step 322 of the data request transaction method 300 shown in FIG. 3. The data can take the form of images, text, or any other information. Since XML provides for multiple types of data in a single transferred file using user-defined tags, the images, text, or other information are segmented by the XML decoder accordingly as shown in step 324 of FIG. 3. The alignment data included in the XML file in the reply signal 418 indicates the location in the XML file that the different images, text, or other information is stored.

The client application 230 of the defect source identifier client 104 receives the decoded data structure (including the images, text, and/or other information) from the XML decoder 236 in 419. The client application 230 of the defect source identifier client 104 then sends a disconnect request in 420. The defect source identifier adapter 234 sends the disconnect request in 421 to the communication server 240 in step 326 of data request transaction method 300 shown in FIG. 3. In 422, the defect source identifier communication server 240 closes the opened socket and terminates the related thread relating to the request transaction 400 in response to the disconnect request 421 as shown in step 328 of FIG. 3.

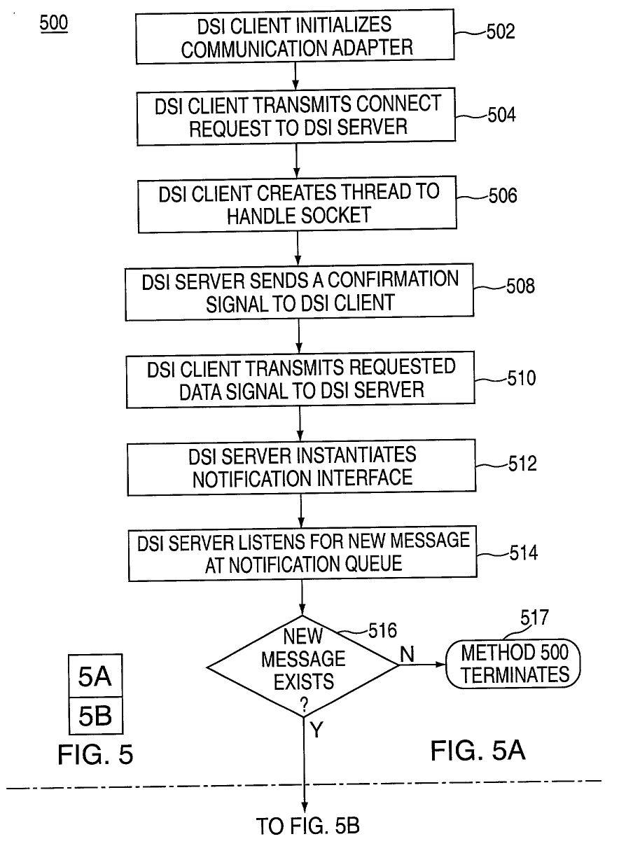

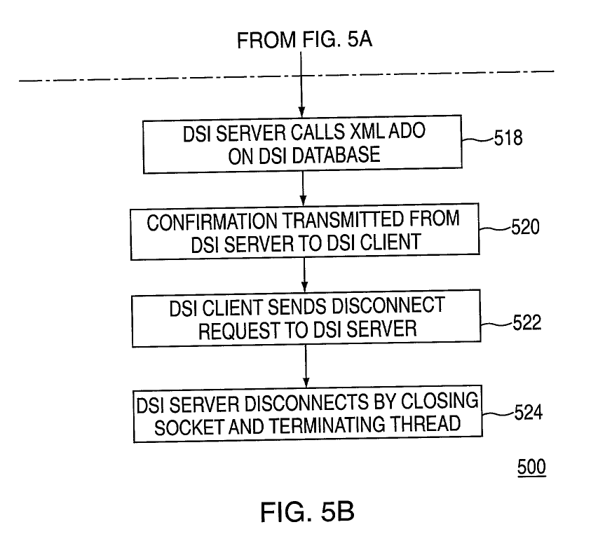

FIG. 5A and 5B together depict a flow diagram of a notification transaction method 500. FIG. 6 depicts the signal sequence diagram of the notification transaction method as performed between the defect source identifier client 104 and the defect source identifier server 106, shown in FIG. 2. FIGS. 2, 5, and 6 should be viewed simultaneously with reference to the following description. The notification transaction method 600 starts when the application and database tier 231 of the defect source identifier client 104 initializes a communication adapter 234 using signal 601, as shown in step 502 of FIG. 5. The communication adapter 234 transmits a connect request signal 603 to the communication server 240 of the defect source identifier server 106 in step 504 of FIG. 5. The defect source identifier client 104 sleeps in 602 and waits for a return of a confirmation signal 605 for a prescribed timeout period. The communication adapter creates a thread including a socket (the socket corresponds to the notification transaction 600), and sends the socket via the connect request signal 603 to the communication server 240. The defect source identifier server 106 waits following the receipt of the connect request signal 603 and listens in 604 for a new connect request. Upon receipt of a new connect request signal, a new thread for handling the socket is started in step 506 of the embodiment of data notification transaction method 500 shown in FIG. 5.

The communication server 240 sends a confirmation signal 605 to the communication adapter 234 of the defect source identifier client 104 in step 508 of the data notification transaction method 500 sown in FIG. 5. After the defect source identifier client 104 is waken by the confirmation signal 605. The client application 230 of the defect source identifier client 104 transmits a requested data signal 606 (preferably, in XML format to limit the necessity for decoding into XML) to the communication adapter 234 in step 510 of the data notification transaction method 500. The defect source identifier client waits by sleeping in 607 for a prescribed timeout period.

The communication adapter 234 sends a request data signal 608 to the communication server 240 of the defect source identifier server 106. The communication server 240 receives the request data signal 608 and, in a separate thread by sending a corresponding message 609, instantiates a notification interface 242 in step 512 of the data notification transaction method 500 shown in FIG. 5. The message 609 includes a notification portion and the connection ID portion. The notification listener process 252 or 262 listens in 610 to the notification queue 250 or 260 for a new message received by the notification queue in step 514 of the data notification transaction method 500 shown in FIG. 5. The data notification transaction method 500 continues to decision step 516 in which, if there is a new message detected by the notification listener process 610, the defect source identifier server 106 continues to step 518 by calling the XML ADO 264 or 264 interface to perform the XML ADO in 611 with the defect source identifier database 408. If the answer to decision step 516 is no, the data notification transaction method 500 terminates as shown by 517 in FIG. 5. Data is stored in the defect source identifier database 408 in XML format. The communication server 240 sends an acknowledgement code 612 in step 220 of the data notification transaction method 500 to the defect source identifier communication adapter 234 of the defect source identifier client 104 that acts as a confirmation of the notification. In 613, the defect source identifier communication adapter 234 of the defect source identifier client 104 receives its confirmation for the notification.

The defect source identifier client 104 can then close the socket to terminate the notification transaction 600. In 614 of FIG. 6, and step 522 of FIG. 5, the defect source identifier adapter sends a disconnect request to the defect source identifier communication adapter 234. In 615, the defect source identifier communication adapter 234 sends a terminate the defect source identifier notification transaction 600 in 615. The defect source identifier communication server closes the opened socket and terminates the related thread in step 524 of FIG. 5 to terminate the notification transaction 600, following receipt of 615.

Although various embodiments which incorporate the teachings of the present invention have been shown and described in detail herein, those skilled in the art can readily devise many other varied embodiments that still incorporate these teachings.

1. A method of communicating defect information between a defect source identifier client and server comprising:
creating defect inspection information within a defect source identifier client, the defect inspection information containing information regarding identified defects on semiconductor wafers;
converting the defect inspection information into converted defect inspection information that is in a form defined by user defined tags;
transmitting the converted defect inspection information through a network to a defect source identifier server; and
deriving defect source information at the defect source identifier server in response to the converted defect inspection information.

2. The method of claim 1, wherein the converted defect inspection information is in the form of extensible markup language (XML).

3. The method of claim 1, wherein the defect source information is in the form of XML.

4. The method of claim 1, wherein the defects on the semiconductor wafer are identified in a metrology cell in a wafer processing system.

5. The method of claim 1, further comprising:
transmitting the defect source information from the defect source identifier server to the defect source identifier client; and
utilizing the defect source information at the defect source identifier client.

6. The method of claim 5, wherein the defect source information and the defect inspection information are displayed simultaneously at the defect source identifier client.

7. The method of claim 5, further comprising:
providing defect reference information at the defect source identifier server;
transmitting the defect reference information from the defect source identifier server to the defect source identifier client; and
displaying the defect reference information at the defect source identifier client.

8. The method of claim 5, wherein the transmission of the defect reference information from the defect source identifier server to the defect source identifier client is controlled by user input at the defect source identifier client.

9. The method of claim 5, wherein the defect source information and the defect reference information are displayed simultaneously at the defect source identifier client.

10. The method of claim 1, wherein the utilizing the defect solution information involves displaying defect solutions to the defect at the defect source identifier client in response to the defect solution information.

11. A method of communicating defect information between a defect source identifier server and client comprising:
creating defect inspection information within a defect source identifier client, the defect inspection information containing information regarding identified defects on semiconductor wafers;
converting the defect inspection information into converted defect inspection information, wherein the converted defect inspection information is in the form of extensible markup language (XML);
transmitting the converted defect inspection information through a network to a defect source identifier server;
deriving defect reference information at the defect source identifier server in response to the converted defect inspection information, wherein the defect reference information is in the form of XML;
transmitting the defect reference information from the defect source identifier server to the defect source identifier client; and
utilizing the defect reference information at the defect source identifier client.

12. The method of claim 11, wherein the defect reference information includes solutions.

13. The method of claim 11, wherein the defects on the semiconductor wafer are identified in a metrology cell in a wafer processing system.

14. The method of claim 11, wherein the defect reference information and the defect inspection information are displayed simultaneously at the defect source identifier client.

15. The method of claim 11, further comprising:
displaying the defect reference information at the defect source identifier client.

16. The method of claim 11 wherein the transmission of the defect reference information from the defect source identifier server to the defect source identifier client is controlled by user input at the defect source identifier client.

17. The method of claim 11, wherein the defect source information and the defect reference information are displayed simultaneously at the defect source identifier client.

18. The method of claim 11, wherein the utilizing the defect solution information involves displaying defect solutions to the defect at the defect source identifier client in response to the defect reference information.

19. An apparatus for communicating defect information between defect source identifier server and clients comprising:
a metrology tool creating defect inspection information, the defect inspection information containing information regarding identified defects on semiconductor wafers;
a converter converting the defect inspection information into converted defect inspection information that is in a form defined by user defined tags;
a network that transmitting converted defect inspection information to a defect source identifier server; and
the defect source identifier server deriving defect source information in response to the converted defect inspection information.

20. The apparatus of claim 19, wherein the converter is an extensible markup language (XML) converter.

21. The apparatus of claim 19, wherein the defect source information is in the form of XML.

22. The apparatus of claim 19, further comprising:
the network transmitting the defect source information from the defect source identifier server to the defect source identifier client; and
the defect source identifier client utilizing the defect source information.

23. The apparatus of claim 22, wherein the defect source identifier client simultaneously displays defect source information and the defect inspection information.

24. The apparatus of claim 19, further comprising:
the defect source identifier server providing defect reference information;
the network transmitting the defect reference information from the defect source identifier server to the defect source identifier client; and
the defect source identifier client displaying the defect reference information.

25. The apparatus of claim 24, wherein the network transmitting the defect reference information from the defect source identifier server to the defect source identifier client is controlled by user input at the defect source identifier client.

26. The apparatus of claim 24, wherein the defect source identifier client simultaneously displays the defect source information and the defect reference information.

27. The apparatus of claim 19, wherein the defect source identifier client utilizing the defect solution information involves displaying defect solutions.
